(19) United States
(12) Patent Application Publication
(10) Pub. No.: US 2026/0073147 A1
(43) Pub. Date: Mar. 12, 2026

(54) METHOD AND SYSTEM FOR AUTOMATIC DETERMINATION OF HUMAN SENTIMENT

(71) Applicant: GENESYS CLOUD SERVICES, INC., MENLO PARK, CA (US)

(72) Inventors: NELLY DAVID, TEL-AVIV (IL); ROTEM MAOZ, TEL-AVIV (IL); EYAL ORBACH, TEL-AVIV (IL); LEV HAIKIN, TEL-AVIV (IL); AVRAHAM FAIZAKOF, TEL-AVIV (IL)

(73) Assignee: GENESYS CLOUD SERVICES, INC., MENLO PARK, CA (US)

(21) Appl. No.: 19/327,330

(22) Filed: Sep. 12, 2025

Related U.S. Application Data
(60) Provisional application No. 63/693,949, filed on Sep. 12, 2024.

(51) Int. Cl. G06F 40/30

(52) U.S. Cl. CPC G06F 40/30

(57) ABSTRACT

A system and method of determining a sentiment of a participant in an interaction may include: obtaining a plurality of textual segments, each representing a portion of the interaction, and labeled according to a specific participant; inferring a language model on one or more textual segments of the plurality of textual segments, to generate respective semantic embedding vectors, each representing a semantic meaning of the respective textual segment in a semantic vector space; compiling a semantic vector set that includes (i) a target semantic embedding vector, corresponding to a target textual segment of a target participant, and (ii) one or more peripheral semantic embedding vectors, respectively corresponding to one or more peripheral textual segments of the plurality of textual segments; and inferring a composite machine-learning (ML)-based model on the semantic vector set, to classify a sentiment of the target participant, as expressed in the target textual segment.

### CLAIM OF PRIORITY

This application claims priority to U.S. provisional patent application 63/693,949, filed 12 Sep. 2024, also titled METHOD AND SYSTEM FOR AUTOMATIC DETERMINATION OF HUMAN SENTIMENT.

### FIELD OF THE INVENTION

The present invention relates generally to the field of natural language processing. More specifically, the present invention relates to automatic determination of human sentiment.

### BACKGROUND OF THE INVENTION

Contact center agents engage in numerous conversations with multiple customers daily. Supervisors of contact centers often seek to analyze these interactions to derive insights and enhance the quality of services provided. To achieve this, it is important to concurrently analyze both the sentiment expressed by customers and the behavior exhibited by agents. For customer utterances, detecting positive or negative sentiment is essential, while for agents, identifying empathetic or unhelpful behavior is necessary.

Existing methods have primarily focused on detecting sentiments from text in various domains, such as social media data, patient-doctor interactions, and general conversations. These methods have employed different computational models, including Support Vector Machines (SVM), Naive Bayes (NB), Logistic Regression (LogR), Long Short-Term Memory (LSTM), and Bidirectional LSTM (BILSTM). However, there has been limited research on simultaneously detecting sentiments of different types of participants (e.g., different role players) in a discussion.

### SUMMARY OF THE INVENTION

Analyzing utterances from different participants, each belonging to different types (e.g., customers and agents), within the context of a discussion is particularly important. The context in which a sentence is spoken can significantly influence its interpretation. For instance, an utterance that appears positive in isolation may convey a different sentiment when considered within the broader context of the conversation. Therefore, understanding the interplay between utterances of different role players in a discussion, can provide more accurate and meaningful insights.

The inventors have experimentally shown that concurrent analysis of utterances of two or more participants in a discussion may have a synergistic effect on the performance of classification of utterance of either one of these participants.

Moreover, by intelligently selecting complementary classification criteria for each of the participants, the inventors have enhanced this synergistic effect, further improving sentiment classification for each of the monitored participants.

Pertaining to the example of contact centers, the inventors have shown that selection of the agent behaviour classification criterion as helpful/unhelpful and/or empathetic/non-empathetic improved the concurrent classification of customer sentiment as positive/negative, and vice-versa.

Embodiments of the invention may include a method of determining, by at least one processor, a sentiment of a participant in an interaction (e.g., a textual chat, a conversation, etc.) that includes a plurality of participants. The at least one processor may obtain a plurality of textual segments, each representing a portion of the interaction, and labeled according to a specific participant. For example, each textual segment may include a data structure such as a vector or matrix, that includes a textual transcription of an utterance in a conversation, adjoint with an identification of a person who has uttered the relevant speech.

According to some embodiments, the at least one processor may infer a pretrained Language Model (LM) on one or more textual segments of the plurality of textual segments, to generate one or more (e.g., a plurality of) respective, semantic embedding vectors. Each semantic embedding vector may represent a semantic meaning of the respective textual segment in a semantic vector space, as known in the art. The at least one processor may compile, or aggregate a semantic vector set based on the plurality of respective semantic embedding vectors. The semantic vector set may include a target semantic embedding vector, corresponding to a target textual segment of a target participant of the plurality of participants. The semantic vector set may further include one or more peripheral semantic embedding vectors, respectively corresponding to one or more peripheral textual segments of the plurality of textual segments.

According to some embodiments, the at least one processor may subsequently infer a composite machine-learning (ML)-based model on the semantic vector set. The at least one processor may thereby classify a behaviour or sentiment of the target participant, as expressed in the target textual segment.

According to some embodiments, the plurality of participants may include the target participant, pertaining to a first participant type, and at least one other participant, pertaining to at least one second, different participant type. The target textual segment and the one or more peripheral textual segments may include a timewise sequence of textual segments of the interaction.

According to some embodiments, the composite ML-based model may include an attention-based encoder model; and at least one sentiment classification model, associated with a specific participant type of the first and second participant types. Each sentiment classification model may pertain to a specific participant type, and may be adapted to classify sentiment of a participant of that type, according to a sentiment criterion that may be relevant to the associated participant type.

According to some embodiments, the at least one processor may be further configured to infer the attention-based encoder model on the semantic vector set, to obtain a context embedding vector, representing a meaning of the target textual segment in a context of the timewise sequence of textual segments.

The at least one processor may subsequently select a sentiment classification model associated with the participant type of the target participant; and infer the selected sentiment classification model on the context embedding vector. The at least one processor may thus classify the sentiment of the target participant, as expressed in the target textual segment, according to the relevant sentiment criterion.

According to some embodiments, the at least one sentiment classification model may include a plurality of sentiment classification models. Each sentiment classification model may be (i) associated with a unique participant type, and (ii) adapted to classify a sentiment of a participant of the associated participant type, according to at least one sentiment criterion that is relevant to the associated participant type.

According to some embodiments, the interaction may include a conversation, or discussion. In such applications, the at least one processor may be further configured to receive an audible representation of the conversation, and apply a speaker recognition algorithm on the audible representation, to partition the audible representation according to recognized participants. The at least one processor may subsequently infer a speech-to-text ML-based model on the partitions of the audible representation, to obtain the plurality of textual segments, and label the plurality of textual segments according to the recognized participants.

According to some embodiments, a first participant type of the first and second participant types may be a call-center agent, and the relevant sentiment criterion may include, for example (i) a helpful behaviour, (ii) an unhelpful behaviour, (iii) an empathic sentiment, and (iv) a non-empathic sentiment. A second participant type of the first and second participant types may complement the first participant type, and have sentiment criteria that complement those of the first participant type. In this example, the second participant type be a call-center client, and the relevant sentiment criterion may include (i) a negative sentiment, and (ii) a positive sentiment. As explained herein, classification of this selection of criteria of the first participant type (e.g., unhelpful behaviour, and empathic sentiment) may have a beneficial, synergic effect on the classification of sentiment of the complementary participant type (e.g., classification of positive and negative sentiments).

According to some embodiments, the at least one processor may be further configured to (e.g., during a training session) receive a training sequence of textual segments, each labeled according to a specific participant. The at least one processor may receive an annotation of a specific textual segment within the training sequence. The annotation may define a sentiment, or behaviour expressed in the specific textual segment, according to at least one of the first sentiment criterion and second sentiment criterion. The at least one processor may thereby generate a semantic vector set based on the textual segments of the training sequence, and use the annotation as supervisory information, to train the composite ML-based model. The at least one processor may subsequently (e.g., during an inference session) classify a sentiment expressed in the specific textual segment according to the first sentiment criterion or second sentiment criterion, based on the semantic vector set.

Additionally, or alternatively, the at least one processor may be further configured to (e.g., during a training session) receive a training sequence of textual segments, each labeled according to a specific participant. The at least one processor may also receive an annotation of a specific textual segment within the training sequence, defining a sentiment expressed in the specific textual segment, according to at least one of the first sentiment criterion and second sentiment criterion. The at least one processor may generate a semantic vector set based on the textual segments of the training sequence; infer the composite ML-based model on the semantic vector set, to classify the specific textual segment according to at least one of the first sentiment criterion and second sentiment criterion; and use said annotation of textual segments as supervisory information, to fine tune the pretrained LM model, based on the classification of the specific textual segment.

Embodiments of the invention may include a system for determining a sentiment of a participant in an interaction that includes a plurality of participants. Embodiments of the system may include a non-transitory memory device, wherein modules of instruction code are stored, and at least one processor associated with the memory device, and configured to execute the modules of instruction code. Upon execution of said modules of instruction code, the at least one processor may be configured to obtain a plurality of textual segments, each representing a portion of the interaction, and labeled according to a specific participant; infer a pretrained LM model on one or more textual segments of the plurality of textual segments, to generate one or more respective, semantic embedding vectors, each representing a semantic meaning of the respective textual segment in a semantic vector space; compile a semantic vector set may include: (i) a target semantic embedding vector, corresponding to a target textual segment of a target participant of the plurality of participants, and (ii) one or more peripheral semantic embedding vectors, respectively corresponding to one or more peripheral textual segments of the plurality of textual segments; and infer a composite ML-based model on the semantic vector set, to classify a sentiment of the target participant, as expressed in the target textual segment.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a block diagram, depicting a computing device which may be included in a system for automatic determination of human sentiment, according to some embodiments; and

FIG. 2 is a block diagram, depicting a system for automatic determination of human sentiment, according to some embodiments;

FIG. 3 is a block diagram, depicting an example of data flow through the system for automatic determination of human sentiment, according to some embodiments; and

FIG. 4 is a flow diagram, depicting stages in a method of automatic determination of human sentiment, according to some embodiments.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term “set” when used herein may include one or more items.

Unless explicitly stated, the method embodiments described herein are not constrained to a particular order or sequence. Additionally, some of the described method embodiments or elements thereof can occur or be performed simultaneously, at the same point in time, or concurrently.

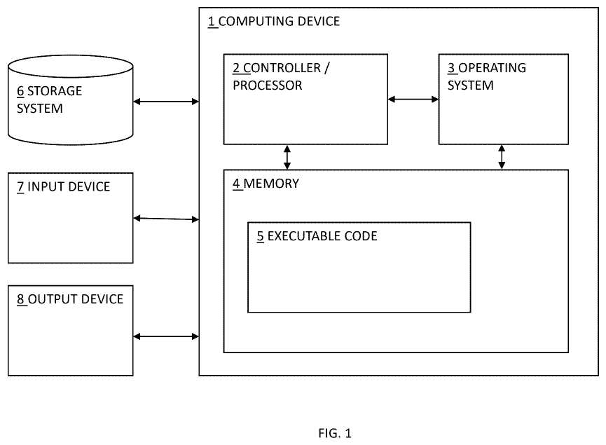

Reference is now made to FIG. 1, which is a block diagram depicting a computing device, which may be included within an embodiment of a system for automatic determination of human sentiment, according to some embodiments.

Computing device 1 may include a processor or controller 2 that may be, for example, a central processing unit (CPU) processor, a chip or any suitable computing or computational device, an operating system 3, a memory 4, executable code 5, a storage system 6, input devices 7 and output devices 8. Processor 2 (or one or more controllers or processors, possibly across multiple units or devices) may be configured to carry out methods described herein, and/or to execute or act as the various modules, units, etc. More than one computing device 1 may be included in, and one or more computing devices 1 may act as the components of, a system according to embodiments of the invention.

Operating system 3 may be or may include any code segment (e.g., one similar to executable code 5 described herein) designed and/or configured to perform tasks involving coordination, scheduling, arbitration, supervising, controlling or otherwise managing operation of computing device 1, for example, scheduling execution of software programs or tasks or enabling software programs or other modules or units to communicate. Operating system 3 may be a commercial operating system. It will be noted that an operating system 3 may be an optional component, e.g., in some embodiments, a system may include a computing device that does not require or include an operating system 3.

Memory 4 may be or may include, for example, a Random-Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 4 may be or may include a plurality of possibly different memory units. Memory 4 may be a computer or processor non-transitory readable medium, or a computer non-transitory storage medium, e.g., a RAM. In one embodiment, a non-transitory storage medium such as memory 4, a hard disk drive, another storage device, etc. may store instructions or code which when executed by a processor may cause the processor to carry out methods as described herein.

Executable code 5 may be any executable code, e.g., an application, a program, a process, task, or script. Executable code 5 may be executed by processor or controller 2 possibly under control of operating system 3. For example, executable code 5 may be an application that may automatically determine human sentiment, as further described herein. Although, for the sake of clarity, a single item of executable code 5 is shown in FIG. 1, a system according to some embodiments of the invention may include a plurality of executable code segments similar to executable code 5 that may be loaded into memory 4 and cause processor 2 to carry out methods described herein.

Storage system 6 may be or may include, for example, a flash memory as known in the art, a memory that is internal to, or embedded in, a micro controller or chip as known in the art, a hard disk drive, a CD-Recordable (CD-R) drive, a Blu-ray disk (BD), a universal serial bus (USB) device or other suitable removable and/or fixed storage unit. Textual data pertaining to utterances, chats, transcriptions etc. may be stored in storage system 6 and may be loaded from storage system 6 into memory 4 where it may be processed by processor or controller 2. In some embodiments, some of the components shown in FIG. 1 may be omitted. For example, memory 4 may be a non-volatile memory having the storage capacity of storage system 6. Accordingly, although shown as a separate component, storage system 6 may be embedded or included in memory 4.

Input devices 7 may be or may include any suitable input devices, components, or systems, e.g., a detachable keyboard or keypad, a mouse and the like. Output devices 8 may include one or more (possibly detachable) displays or monitors, speakers and/or any other suitable output devices. Any applicable input/output (I/O) devices may be connected to Computing device 1 as shown by blocks 7 and 8. For example, a wired or wireless network interface card (NIC), a universal serial bus (USB) device or external hard drive may be included in input devices 7 and/or output devices 8. It will be recognized that any suitable number of input devices 7 and output device 8 may be operatively connected to Computing device 1 as shown by blocks 7 and 8.

A system according to some embodiments of the invention may include components such as, but not limited to, a plurality of central processing units (CPU) or any other suitable multi-purpose or specific processors or controllers (e.g., similar to element 2), a plurality of input units, a plurality of output units, a plurality of memory units, and a plurality of storage units.

The term neural network (NN) or artificial neural network (ANN), e.g., a neural network implementing a machine learning (ML) or artificial intelligence (AI) function, may be used herein to refer to an information processing paradigm that may include nodes, referred to as neurons, organized into layers, with links between the neurons. The links may transfer signals between neurons and may be associated with weights. A NN may be configured or trained for a specific task, e.g., pattern recognition or classification. Training a NN for the specific task may involve adjusting these weights based on examples. Each neuron of an intermediate or last layer may receive an input signal, e.g., a weighted sum of output signals from other neurons, and may process the input signal using a linear or nonlinear function (e.g., an activation function). The results of the input and intermediate layers may be transferred to other neurons and the results of the output layer may be provided as the output of the NN. Typically, the neurons and links within a NN are represented by mathematical constructs, such as activation functions and matrices of data elements and weights. At least one processor (e.g., processor 2 of FIG. 1) such as one or more CPUs or graphics processing units (GPUs), or a dedicated hardware device may perform the relevant calculations.

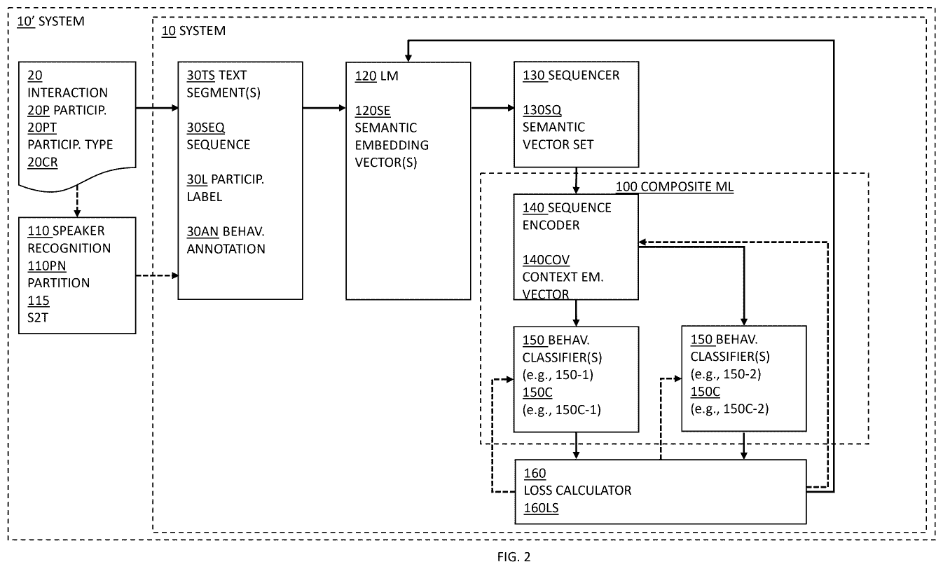

Reference is now made to FIG. 2, which depicts a system 10 for automatic determination of human sentiment, according to some embodiments.

According to some embodiments of the invention, system 10 may be implemented as a software module, a hardware module, or any combination thereof. For example, system may be or may include a computing device such as element 1 of FIG. 1, and may be adapted to execute one or more modules of executable code (e.g., element 5 of FIG. 1) to automatically determine human sentiment, as further described herein.

As shown in FIG. 2, arrows may represent flow of one or more data elements to and from system 10 and/or among modules or elements of system 10. Some arrows have been omitted in FIG. 2 for the purpose of clarity.

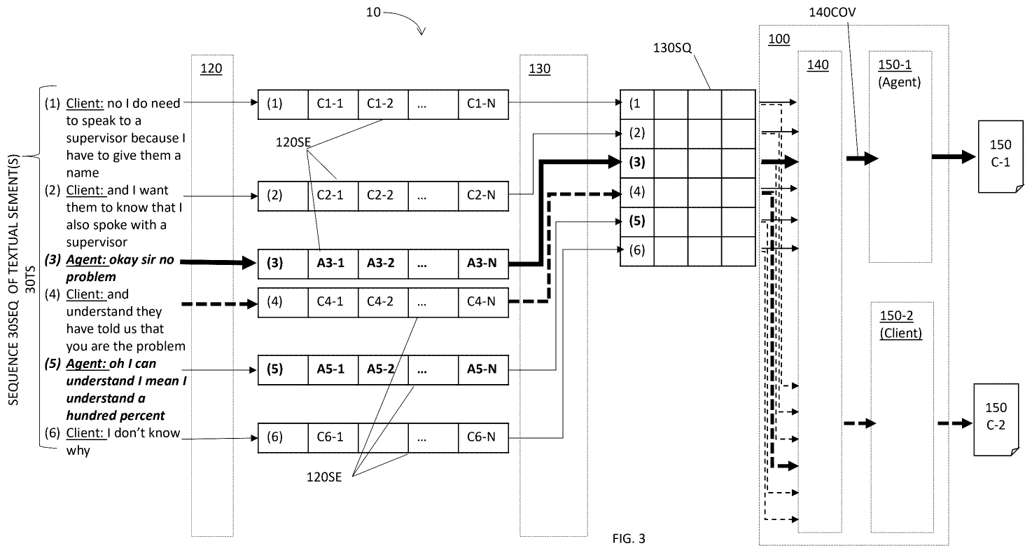

Reference is also made to FIG. 3, which is a block diagram, depicting an example of data flow through system 10 (e.g., same as system 10 of FIG. 2) for automatic determination of human sentiment, according to some embodiments.

According to some embodiments, system 10 may obtain (e.g., from input device 7 of FIG. 1) a plurality of textual segments 30TS. Each textual segment 30TS may represent a portion of an interaction 20 among a plurality of participants 20P.

For example, interaction 20 may be a data structure (e.g., an audio file, a stream of audiovisual content and the like), that may include an audible representation of a discussion, or a conversation between two or more participants 20P. In such applications, each textual segment 30TS may represent, for example, an utterance, a sub-word, a word, a sentence, and the like.

System 10 may receive the audible representation 20 of the conversation, and apply a machine-learning (ML) based speaker recognition 110 algorithm on the audible representation, to partition 110PN the audible representation according to recognized participants. Speaker recognition 110 algorithm may further produce participant labels 30L, identifying specific speakers 20P in each partition 110PN, as known in the art.

System 10 may subsequently infer an ML-based speech-to-text model on the partitions 110PN of the audible representation 20, to obtain the plurality of textual segments 30TS. System 10 may proceed to assign, or associate participant labels 30L with respective of textual segments 30TS, according to the recognized participants, such that one or more (e.g., each) textual segments 30TS is identified or labeled according to a specific, respective participant or speaker 20P.

In the example of FIG. 3, the received textual segments 30TS include six sentences in textual format, originating from an interaction (e.g., discussion) 20 between an agent participant 20P and a client participant 20P in a call center. Each sentence is labeled (e.g., ‘Agent’/‘Client’) according to its respective participant or speaker 20P in the discussion 20.

In another example, interaction 20 may include a textual interaction, such as an online chat, among two or more participants 20P, such as a client, and an agent on a customer-support website. In such applications, each textual segment 30TS may represent one entry in the textual interaction, and may already be labeled 30L according to the participant's 20P identity (e.g., their name), and/or according to their type or role (e.g., client, agent) in the transaction.

System 10 may include an ML-based, Language Model (LM) or Large Language Model 120. LM model 120 may, for example include a transformer-based ML model such as a Bidirectional Encoder Representations from Transformers (BERT), or a subsidiary thereof. LM model 120 may be pretrained, as known in the art, to receive a textual data element of interest as input, and generate a semantic embedding vector, representing a semantic meaning of the textual data element of interest in a semantic vector space.

As known in the art, LM model 120 may be pretrained such that a pair of incident textual data elements of similar semantic meaning may produce a respective pair of semantic vectors having a small relative difference between them, in the semantic vector space. In a complementary manner, LM model 120 may be pretrained such that a pair of incident textual data elements of dissimilar semantic meaning may produce a respective pair of semantic vectors having a large relative distance between them, in the semantic vector space.

According to some embodiments, system 10 may infer pretrained LM model on one or more textual segments 30TS of the plurality of textual segments 30TS, to generate one or more respective, semantic embedding vectors 120SE. Each semantic embedding vector 120SE may represent a semantic meaning of the respective textual segment 30TS in the semantic vector space.

In the example of FIG. 3, textual segments (sentences) 30TS 1, 2, 4 and 6 originate from the call center client, and textual segments (sentences) 30TS 3 and 5 originate from the call center agent, and marked as bold.

Accordingly, N-long semantic embedding vectors 120SE 1, 2, 4 and 6 each represent a respective semantic meaning of corresponding client textual segment 30TS, and are marked with the letter ‘C’ (Client). In a similar manner, each N-long semantic embedding vector 120SE 3 and 5 represent a respective semantic meaning of corresponding agent textual segment 30TS, and are marked with the letter ‘A’ (Agent).

According to some embodiments, the plurality of participants 20P may include a target participant 20P, e.g., a participant 20P of interest. System 10 may be configured to determine a sentiment of target participant 20P, as expressed in a specific, target textual segment 30TS of interest.

The plurality of participants 20P may further include one or more other participants 20P, also referred to herein as “peripheral” participants, who may be interacting 20 (e.g., chatting, discussing) with target participant 20P.

In the example of FIG. 3, a target participant 20P may be the agent, which is marked by bold-font textual segments 30TS. A corresponding target textual segment 30TS of interest may be segment 30TS number (3) (e.g., “okay sir no problem”). Analysis of this target textual segment 30TS may be understood by following FIG. 3, along the bold arrows.

Inventors have experimentally identified an improvement in predicting, or determining a sentiment of a target participant 20P, as expressed in the target textual segment 30TS, when examined in the context of interaction 20 with other, peripheral participants 20. In other words, a context of peripheral textual segments 30TS may provide a synergistic effect. This synergistic effect may allow embodiments of the invention to identify a sentiment expressed in target textual segment 30TS more precisely than when analyzing each textual segment 30TS individually.

For example, a textual segment 30TS that includes the expression “yeah, right” may be understood in an affirmative meaning when studied alone. However, the same expression may be understood as sarcastic, or negative when analyzed within a context of interaction 20, e.g., when other speakers express negative sentiments.

According to some embodiments, target participant 20P may pertain to a first participant type 20PT, and at least one of the one or more peripheral participants 20 may pertain to a second participant type 20PT.

Relating to the example of a customer support chat provided above, target participant 20P may be a support agent, whereas at least one peripheral participant 20P may be a client, seeking the agent's support (or the other way around).

As elaborated herein, embodiments of the invention may be adapted to classify sentiment of each participant, according to a sentiment criterion 20CR that is relevant to the associated participant type 20PT.

For example, interaction 20 may include a recorded discussion between a participant 20P of a first type 20PT, e.g., a call-center agent, and a participant 20P of a second type 20PT, e.g., a call-center client.

Embodiments of the invention may classify a sentiment of a text segment 30TS, originating from a participant 20P of a first type 20PT (e.g., call-center agent) according to a first set of relevant criteria 20CR.

The relevant criteria 20CR in the example of the call-center agent may include, for example (i) a helpful sentiment (e.g., “I would like to help you”), (ii) an unhelpful sentiment (e.g., “I don't know what to do with this information”), (iii) an empathic sentiment (e.g., “I'm very sorry to hear that”), and (iv) a non-empathic sentiment (e.g., not responding when told of the client's misfortune).

Embodiments of the invention may also classify a sentiment of a text segment 30TS, originating from a participant 20P of a second type 20PT (e.g., call-center client) according to a second, different set of relevant criteria 20CR.

The relevant criteria 20CR in the example of the call-center client may include, for example (i) a positive sentiment (e.g., “Thanks for your help”), and (ii) a negative sentiment (e.g., “Expect to hear from my lawyer”).

Inventors have experimentally identified an improvement in predicting, or determining a sentiment of a target participant 20P, as expressed in a target textual segment 30TS, when examined in the context of interaction 20 with participants 20 of other types 20PT.

In other words, training embodiments of the invention to determine sentiments of participants of different (possibly complementary) types 20PT, according to respective, different (possibly complementary) sets of relevant criteria 20CR, may provide a synergistic effect. This synergistic effect may improve precision of sentiment prediction, in relation to individual sentiment prediction according to a single set of sentiment criteria 20CR.

For example, Table 1 below demonstrates the importance of using context when labeling a sentence, by measuring an increase in an Area Under the Curve (AUC) of the Receiver Operating Characteristic (ROC) curve, when analyzing each utterance individually (e.g., using a sequence size of 1), without context, vs. using sequences of 30 segments which include utterances of both participants in a dialog.

TABLE 1

| Class | ΔAUC (%) |
|---|---|
| Empathetic | 24 |
| Unhelpful behaviour | 32 |
| Positive sentiment | 19 |
| Negative sentiment | 18 |

According to some embodiments, system 10 may include a sequencing module (or “sequencer”) 130. As elaborated herein, sequencer 130 may be adapted to compile, or aggregate a semantic vector set 130SQ based one the semantic embedding vector(s) 120SE.

Semantic vector set 130SQ may include a target semantic embedding vector 120SE, corresponding to a target textual segment 30TS of a target participant 20P of the plurality of participants 20P. Semantic vector set 130SQ may further include one or more peripheral semantic embedding vectors 120SE, respectively corresponding to one or more peripheral textual segments 30TS of the plurality of textual segments 30TS.

For example, sequencer 130 may compile semantic vector set 130SQ by selecting semantic embedding vectors 120SE that correspond to unique sequential groups of a predetermined number (e.g., 30) of text segments 30TS.

Additionally, or alternatively, semantic vector sets 130SQ may include semantic embedding vectors 120SE that correspond to sequences of text segments 30TS having a predetermined overlap.

Additionally, or alternatively, semantic vector sets 130SQ may include semantic embedding vectors 120SE that correspond to sequences of text segments 30TS in which a speaker's utterance is uninterrupted by other speakers.

Additionally, or alternatively, sequencer 130 may aggregate a semantic vector set 130SQ of an interaction (e.g., a dialog) as a single sequence of segments, e.g., include all semantic embedding vectors 120SE of the entire interaction.

Additionally, or alternatively, sequencer 130 may generate semantic vector sets 130SQ of an interaction dynamically, over groups of semantic vectors of interest. For example, semantic vector sets 130SQ may be compiled as a sliding window of semantic embedding vectors 120SE, as the interaction (e.g., conversation) progresses.

As shown in the simplified example of FIG. 3, system 10 may be used to identify a sentiment of an Agent, as expressed or manifested in a target textual segment 30TS (e.g., sentence) number (3), i.e., “okay sir no problem”. Following the bold, continuous arrow of FIG. 3, the corresponding target semantic embedding vector 120SE is vector (3): [A3-1, A3-2, . . . , A3-N]. In this example, sequencer 130 may compile semantic vector set 130SQ by aggregating target semantic embedding vector 120SE (e.g., vector (3)) and one or more peripheral semantic embedding vectors 120SE (e.g., vectors (1), (2), and (4-6)).

As elaborated herein, the semantic vector set 130SQ may include at least one semantic embedding vector 120SE pertaining to a first participant type 20PT, and at least one other participant, pertaining to at least one second participant type 20PT.

Additionally, or alternatively, and as shown in the example of FIG. 3, at least one peripheral semantic embedding vector 120SE (e.g., vectors (1), (2), (4) or (6)) of the semantic vector set 130SQ may pertain to a different participant type (e.g., a client type) other than that of the target semantic embedding vector 120SE (e.g., an agent type).

Additionally, or alternatively, at least one peripheral semantic embedding vector 120SE (e.g., vectors (1), (2), (4) or (6)) of the semantic vector set 130SQ may pertain to a participant (e.g., a specific client) other than that of the target semantic embedding vector 120SE (e.g., a specific agent).

According to some embodiments, sequencer 130 may compile semantic vector set 130SQ such that the textual segments 30TS (e.g., the target textual segment 30TS and the one or more peripheral textual segments 30TS) represented by semantic vector set 130SQ may represent a chronologic, or timewise ordered sequence 30SEQ of textual segments 30TS or partitions 110PN of interaction 20. As shown in the example of FIG. 3, the sequence 30SEQ of textual segments 30TS represents an order of sentences in a discussion between the client and agent.

As shown in FIGS. 2 and 3, system 10 may include a Machine-Learning (ML)-based model, referred to herein as a composite ML model 100. System 10 may infer composite ML model 100 on semantic vector set 130SQ, to classify a sentiment of the target participant (e.g., the agent of FIG. 3), as expressed in the target textual segment 30TS (3).

System 10 may infer composite ML model 100 on semantic vector set 130SQ concurrently, e.g., on all member semantic embedding vectors 120SE (target and peripheral) in parallel, substantially at the same time. System 10 may thereby gain the benefit of understanding a context in interaction 20, to accurately classify sentiments expressed in target textual segment 30TS.

As shown in FIGS. 2 and 3, composite ML model 100 may include an attention-based encoder model 140 (or “encoder 140”, for short). Encoder 140 may be adapted to receive as input a group of semantic embedding vectors 120SE, respectively corresponding to a timewise sequence 30SEQ of textual segment 30TS. As elaborated herein, encoder 140 may be trained to generate a context embedding vector 140COV, based on the input group of semantic embedding vectors 120SE. The generated context embedding vector 140COV may represent a meaning of a specific textual segment 30TS, in a context of the timewise sequence 30SEQ of textual segments 30TS.

In other words, context embedding vector 140COV may represent a textual segment 30TS (e.g., a sentence) not just in relation to its semantic meaning, but also in relation to its context within a timewise sequence 30SEQ of textual segment 30TS (e.g., within a conversation).

According to some embodiments, system 10 may (e.g., during an inference stage) infer attention-based encoder model 140 on a semantic vector set 130SQ, that may include (i) a target semantic embedding vector 120SE, corresponding to a target textual segment 30TS, and (ii) one or more peripheral semantic embedding vectors 120SE, respectively corresponding to one or more peripheral textual segment 30TS. System 10 may thus obtain a context embedding vector 140COV, that may represent a meaning of the target textual segment 30TS in a context of the timewise sequence 30SEQ of textual segments.

As shown in the example of FIG. 3, context embedding vector 140COV may represent the meaning of the target textual segment 30TS (“okay sir no problem”) not only within the scope, and sense of this sentence's semantic meaning, but also in the context of the interaction 20 between different participants of different types 20PT.

According to some embodiments, composite ML model 10 may include at least one sentiment classification model 150 (e.g., 150-1, 150-2), associated with a specific, unique participant type 20PT of the first and second participant types 20PT.

Additionally, or alternatively, Each sentiment classification model (or “classifier”, for short) 150 may be adapted to classify sentiment of a participant, according to a sentiment criterion 20CR that is relevant to the associated participant type 20PT.

In other words, composite ML model 10 may include a plurality of sentiment classification models 150, where each sentiment classification model is (i) associated with a unique participant type, and (ii) adapted to classify a sentiment of a participant of the associated participant type, according to at least one sentiment criterion 20CR that is relevant to the associated participant type.

Pertaining to the example depicted in FIG. 3, classifier 150-1 may be uniquely adapted to classify (e.g., produce classification 150C-1) of a sentiment of an agent participant type 20PT, as one of: (i) a helpful sentiment, (ii) an unhelpful sentiment, (iii) an empathic sentiment, a (iv) a non-empathic sentiment, and (v) a neutral sentiment.

In a complementary manner, classifier 150-2 of FIG. 3 may be uniquely adapted to classify (e.g., produce classification 150C-2) of a sentiment of a client participant type 20PT, as one of: (i) a negative sentiment, (ii) a positive sentiment, and (iii) a neutral sentiment.

According to some embodiments, system 10 may (e.g., during an inference stage) select a sentiment classification model 150 (e.g., classifier 150-1, 150-2) associated with the participant type 20PT of the target participant 20P.

In the example depicted in FIG. 3, to classify a sentiment of the target participant 20P (the agent), as expressed in the target textual segment (e.g., sentence (3), “okay sir no problem”), system 10 would follow the bold continuous arrow, and select classifier 150-1. In a complementary manner, to classify a sentiment of another target participant 20P (the client), as expressed in another textual segment (e.g., sentence (4), “and understand they have told us you are the problem”), system 10 would follow the bold, dashed arrow, and select classifier 150-2.

System 10 may proceed to infer the selected sentiment classification model (e.g., 150-1 or 150-2) on context embedding vector 140COV, to classify (or produce a classification 150C (e.g., 150C-1, 150C-2)) of the sentiment of the target participant 20P, as expressed in the target textual segment 30TS, according to the relevant sentiment criterion 20CR.

According to some embodiments, system 10 may (e.g., during a training stage) receive a training sequence 30SEQ of textual segments 30TS, where one or more (e.g., each) textual segment 30TS is labeled according to a specific participant 20P. System 10 may also receive (e.g., via input 7 of FIG. 1) an annotation 30AN of at least one specific textual segment 30TS within the training sequence 30SEQ. Annotation 30AN may define a sentiment expressed in the specific textual segment, according to an appropriate sentiment criterion 20CR.

In the example of FIG. 3, a relevant sentiment criterion 20CR for annotation 30AN of a client-type 20PT participant 20P may be a negative/positive/neutral sentiment. In a similar manner, an appropriate sentiment criterion 20CR for annotation 30AN of an agent-type 20PT participant 20P may be a helpful/unhelpful/neutral criterion 20CR, or an empathic/non-empathic/neutral criterion 20CR.

System 10 may then generate a semantic vector set 130SQ based on the textual segments of the training sequence 30SEQ, as elaborated herein.

System 10 may subsequently utilize a training scheme (e.g., a backward propagation scheme), to train the composite ML model 10, while using annotations 30AN as supervisory information.

For example, system 10 may include a loss calculation module 160, adapted to calculate a loss value 160LS, representing a difference between outcome (e.g. prediction 150C) of at least one classifier 150, and a corresponding annotation 30A. As shown by the dashed arrows of FIG. 2, system 10 may use loss value 160LS as feedback for training encoder 140 and/or any one of classifiers 150.

It may be appreciated that classifier(s) 150 may be trained separately from encoder 140. For example, weights of encoder 140 may be kept constant (e.g., “frozen”), while values of weights of classifier(s) 150 are adjusted based on loss value 160LS, according to a backward propagation scheme. In a complementary manner, encoder 140 may be trained separately from any one of classifier(s) 150. For example, weights of classifier(s) 150 may be kept constant, while values of weights of encoder 140 are adjusted based on loss value 160LS, according to a backward propagation scheme.

The composite ML-based model 10 may be thus be trained to classify 150C a sentiment expressed in the annotated textual segment 30TS, according to the relevant sentiment criterion 20CR (e.g., a first criterion 20CR for client types 20PT, and a second criterion 20CR for agent types 20PT), based on the semantic vector set 130SQ.

In a subsequent, inference stage, composite ML-based model 10 may be configured to receive a semantic vector set 130SQ representing a semantic meaning of a target textual segment 30TS of interest in a context of a sequence 30SEQ of related textual segment 30TS. Based on its training, composite ML-based model 10 may determine a sentiment expressed in the target textual segment, according to at least one relevant criterion 20CR.

It may be appreciated that training of composite ML-based model 10 may precede a subsequent inference of composite ML-based model 10 on incoming semantic vector set 130SQ. Additionally, or alternatively, the training and inference stages of composite ML-based model 10 may be intermittent, allowing system 10 to refine the training of composite ML-based model 10 over time.

Additionally, or alternatively, system 10 may retrain, or fine-tune the training of LM model 120, based on loss value 160LS, either in conjunction with, or separately from the training of composite ML model 100.

As elaborated herein, system 10 may generate a semantic vector set 130SQ based on textual segments 30TS of a training sequence 30SEQ. According to some embodiments, system 10 may proceed to infer composite ML-based model 100 on the semantic vector set 130SQ, to classify a specific textual segments 30TS of the training sequence 30SEQ according to at least one relevant sentiment criterion 20CR (e.g., a first criterion 20CR for client types 20PT, and a second criterion 20CR for agent types 20PT).

System 10 may then use the annotation 30AN of textual segments as supervisory information, to fine tune the pretrained LM model, based on the classification of the specific textual segment. For example, system 10 may calculate a loss value 160LS, representing a difference between outcome (e.g. prediction 150C) of at least one classifier 150, and a corresponding annotation 30A. As shown by the continuous feedback arrow of FIG. 2, system 10 may use loss value 160LS as feedback for retraining LM model 120.

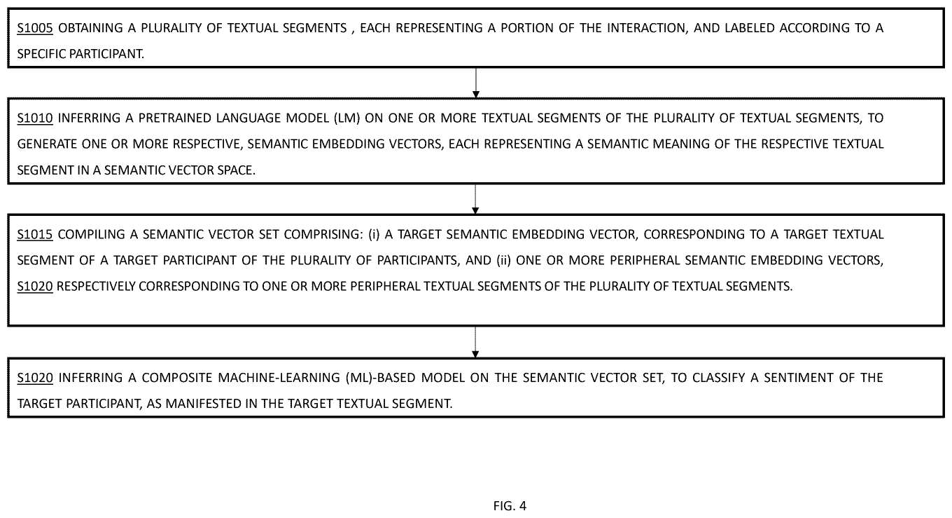

Reference is now made to FIG. 4, which is a flow diagram depicting stages in a method of automatically determining human sentiment of a participant in an interaction (e.g., a dialog) by at least one processor (e.g., processor 2 of FIG. 1), according to some embodiments of the invention.

As shown in step S1005, the at least one processor may obtain (e.g., via a speech to text 115 application) a plurality of textual segments (e.g., 30TS of FIG. 2). Each textual segment 30TS may represent a portion of interaction 20, and may be labeled according to a specific participant 20P.

As shown in step S1010, the at least one processor 2 may infer a pretrained language model (e.g., LM 120 of FIG. 2) on one or more textual segments 30TS of the plurality of textual segments, to generate one or more respective, semantic embedding vectors (e.g., 120SE of FIG. 2). As known in the art, each semantic embedding vector 120SE may represent a semantic meaning of the respective textual segment 30TS in a semantic vector space.

As shown in step S1015, the at least one processor 2 may compile a semantic vector set 130SQ from the one or more semantic embedding vectors 120SE.

The semantic vector set 130SQ may include a target semantic embedding vector 120SE, e.g., one that corresponds to a target textual segment 30TS of a target participant of the plurality of participants. The semantic vector set 130SQ may further include one or more peripheral semantic embedding vectors, respectively corresponding to one or more peripheral textual segments of the plurality of textual segments.

Additionally, or alternatively, embodiments of the invention may concurrently analyze and classify a plurality of (e.g., all) textual segment 30TS of semantic vector set 130SQ.

As shown in step S1020, the at least one processor 2 may infer a composite ML-based model (e.g., ML 100 of FIG. 2) on semantic vector set 130SQ, to classify (e.g., produce classification 150C, e.g., 150C-1, 150C-2 of FIG. 2 of) a sentiment of the target participant 20P, as expressed in the respective target textual segment 30TS.

As elaborated herein, the present invention provides a practical application in the technological field of natural language processing. The inventors have shown the synergistic effect in concurrent classification of complementary sentiments, in speech or text originating from two or more participants of complimentary types.

As explained herein, embodiments of the invention may thereby fine tune classification of human utterance, allowing understanding and detection of subtle, nuanced behaviour.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method of determining, by at least one processor, a sentiment of a participant in an interaction comprising a plurality of participants, the method comprising:
obtaining a plurality of textual segments, each representing a portion of the interaction, and labeled according to a specific participant;
inferring a pretrained Language Model (LM) on one or more textual segments of the plurality of textual segments, to generate one or more respective, semantic embedding vectors, each representing a semantic meaning of the respective textual segment in a semantic vector space;
compiling a semantic vector set comprising: (i) a target semantic embedding vector, corresponding to a target textual segment of a target participant of the plurality of participants, and (ii) one or more peripheral semantic embedding vectors, respectively corresponding to one or more peripheral textual segments of the plurality of textual segments; and
inferring a composite machine-learning (ML)-based model on the semantic vector set, to classify a sentiment of the target participant, as expressed in the target textual segment.

2. The method of claim 1, wherein the plurality of participants comprise the target participant, pertaining to a first participant type, and at least one other participant, pertaining to at least one second participant type.

3. The method of claim 2, wherein the target textual segment and the one or more peripheral textual segments comprise a timewise sequence of textual segments of the interaction.

4. The method of claim 3, wherein the composite ML-based model comprises:
an attention-based encoder model; and
at least one sentiment classification model, associated with a specific participant type of the first and second participant types,
wherein each sentiment classification model is adapted to classify sentiment of a participant, according to a sentiment criterion that is relevant to the associated participant type.

5. The method of claim 4, further comprising:
inferring the attention-based encoder model on the semantic vector set, to obtain a context embedding vector, representing a meaning of the target textual segment in a context of the timewise sequence of textual segments;
selecting a sentiment classification model associated with the participant type of the target participant; and
inferring the selected sentiment classification model on the context embedding vector, to classify the sentiment of the target participant, as expressed in the target textual segment, according to the relevant sentiment criterion.

6. The method of claim 4, wherein the at least one sentiment classification model comprises a plurality of sentiment classification models,
wherein each sentiment classification model is (i) associated with a unique participant type, and (ii) adapted to classify a sentiment of a participant of the associated participant type, according to at least one sentiment criterion that is relevant to the associated participant type.

7. The method of claim 6, wherein the interaction comprises a conversation, and wherein the method further comprises:
receiving an audible representation of the conversation;
applying a speaker recognition algorithm on the audible representation, to partition the audible representation according to recognized participants;
inferring a speech-to-text ML-based model on the partitions of the audible representation, to obtain the plurality of textual segments; and
labeling the plurality of textual segments according to the recognized participants.

8. The method of claim 7, wherein one participant type of the first participant type and second participant type is a call-center agent, and wherein the relevant sentiment criterion is selected from a list consisting of: (i) helpful sentiment, (ii) unhelpful sentiment, (iii) empathic sentiment, and (iv) non-empathic sentiment.

9. The method of claim 8, wherein another participant type of the first participant type and second participant type is a call-center client, and wherein the relevant sentiment criterion is selected from a list consisting of: (i) a negative sentiment, and (ii) a positive sentiment.

10. The method of claim 7, further comprising:
receiving a training sequence of textual segments, each labeled according to a specific participant;
receiving an annotation of a specific textual segment within the training sequence, wherein said annotation defines a sentiment expressed in the specific textual segment, according to at least one of the first sentiment criterion and a second sentiment criterion;
generating a semantic vector set based on the textual segments of the training sequence; and
using said annotation as supervisory information, to train the composite ML-based model, so as to classify a sentiment expressed in the specific textual segment according to the first sentiment criterion or second sentiment criterion, based on the semantic vector set.

11. The method of claim 7, further comprising:
receiving a training sequence of textual segments, each labeled according to a specific participant;
receiving an annotation of a specific textual segment within the training sequence, wherein said annotation defines a sentiment expressed in the specific textual segment, according to at least one of the first sentiment criterion and a second sentiment criterion;
generating a semantic vector set based on the textual segments of the training sequence;
inferring the composite ML-based model on the semantic vector set, to classify the specific textual segment according to at least one of the first sentiment criterion and second sentiment criterion; and
using said annotation of textual segments as supervisory information, to fine tune the pretrained LM model, based on the classification of the specific textual segment.

12. A system for determining a sentiment of a participant in an interaction comprising a plurality of participants, the system comprising: a non-transitory memory device, wherein modules of instruction code are stored, and at least one processor associated with the memory device, and configured to execute the modules of instruction code, whereupon execution of said modules of instruction code, the at least one processor is configured to:
obtain a plurality of textual segments, each representing a portion of the interaction, and labeled according to a specific participant;
infer a pretrained LM model on one or more textual segments of the plurality of textual segments, to generate one or more respective, semantic embedding vectors, each representing a semantic meaning of the respective textual segment in a semantic vector space;
compile a semantic vector set comprising: (i) a target semantic embedding vector, corresponding to a target textual segment of a target participant of the plurality of participants, and (ii) one or more peripheral semantic embedding vectors, respectively corresponding to one or more peripheral textual segments of the plurality of textual segments; and
infer a composite ML-based model on the semantic vector set, to classify a sentiment of the target participant, as expressed in the target textual segment.

13. The system of claim 12, wherein the plurality of participants comprise the target participant, pertaining to a first participant type, and at least one other participant, pertaining to at least one second, different participant type.

14. The system of claim 13, wherein the target textual segment and the one or more peripheral textual segments comprise a timewise sequence of textual segments of the interaction.

15. The system of claim 14, wherein the composite ML-based model comprises:
an attention-based encoder model; and
at least one sentiment classification model, associated with a specific participant type of the first and second participant types,
wherein each sentiment classification model is adapted to classify sentiment of a participant, according to a sentiment criterion that is relevant to the associated participant type.

16. The system of claim 15, wherein the at least one processor is further configured to:
infer the attention-based encoder model on the semantic vector set, to obtain a context embedding vector, representing a meaning of the target textual segment in a context of the timewise sequence of textual segments;
select a sentiment classification model associated with the participant type of the target participant; and
infer the selected sentiment classification model on the context embedding vector, to classify the sentiment of the target participant, as expressed in the target textual segment, according to the relevant sentiment criterion.

17. The system of claim 15, wherein the at least one sentiment classification model comprises a plurality of sentiment classification models,
wherein each sentiment classification model is (i) associated with a unique participant type, and (ii) adapted to classify a sentiment of a participant of the associated participant type, according to at least one sentiment criterion that is relevant to the associated participant type.

18. The system of claim 17, wherein the interaction comprises a conversation, and wherein the at least one processor is further configured to:
receive an audible representation of the conversation;
apply a speaker recognition algorithm on the audible representation, to partition the audible representation according to recognized participants;
infer a speech-to-text ML-based model on the partitions of the audible representation, to obtain the plurality of textual segments; and
label the plurality of textual segments according to the recognized participants.

19. The system of claim 18, wherein one participant type of the first participant type and second participant type is a call-center agent, and wherein the relevant sentiment criterion is selected from a list consisting of: (i) helpful sentiment, (ii) unhelpful sentiment, (iii) empathic sentiment, and (iv) non-empathic sentiment.

20. The system of claim 19, wherein another participant type of the first participant type and second participant type is a call-center client, and wherein the relevant sentiment criterion is selected from a list consisting of: (i) a negative sentiment, and (ii) a positive sentiment.
